(19) United States
(12) Patent Application Publication
(10) Pub. No.: US 2026/0148270 A1
(43) Pub. Date: May 28, 2026

(54) METHODS AND SYSTEMS FOR OBTAINING CASH OR CASH EQUIVALENT DEPOSITS FROM POTENTIAL PURCHASERS FOR ONLINE PURCHASE TRANSACTIONS

(71) Applicants: Andre Christopher Cuadrado, Naples, FL (US); Michael Edward Jimenez, Naples, FL (US)

(72) Inventors: Andre Christopher Cuadrado, Naples, FL (US); Michael Edward Jimenez, Naples, FL (US)

(21) Appl. No.: 18/957,642

(22) Filed: Nov. 22, 2024

(51) Int. Cl. G06Q 30/0601; G06Q 30/08

(52) U.S. Cl. CPC G06Q 30/0609; G06Q 30/08

(57) ABSTRACT

Methods and systems comprising a memory comprising computer-executable instructions, one or more processors in communication with the memory and configured to access the memory and execute the computer-executable instructions to at least, generate information or instructions regarding (1) one or more sellers or one or more assets of value (2) one or more potential purchasers or the one or more assets of value (3) the cash or cash equivalent deposit that the one or more potential purchasers paid, (4) the transfer of at least a portion of the cash or cash equivalent deposit paid by the one or more potential purchaser, (5) or receiving instructions from the one or more potential purchasers to purchase one or more assets of value and (6) the cash or cash equivalent deposit received from the one or more purchasers.

### FIELD OF THE DISCLOSURE

The present disclosure relates to various methods and systems for obtaining cash or cash equivalent deposits from one or more potential purchasers of one or more assets of value using an electronic or online platform or application for online purchase transactions of one or more assets of value. For purposes of the present disclosure, one or more assets of value include, but are not limited to loans, debt, real estate, physical items and goods, stocks, futures, equities or any other item that the potential purchaser finds value in.

More specifically, the present disclosure is directed to various methods and systems that provide a variety of benefits, including but not limited to, obtaining the highest price and best terms for the seller of one or more assets of value, avoiding potential purchasers from not following through on their purchase of those assets of value, avoiding transaction fallout and sellers of an asset of value having a bad experience on the platform or application because the prospective purchaser backed out and now the seller's options are to accept the next lowest offer or go back to market again, reducing and simplifying the purchase process for assets of value by giving the sellers of those assets of value an efficient, highly customizable and scalable tool to sell those assets to vetted serious buyers who are more committed and more likely to close, dramatically reducing processing times and costs and maximizing the amount of money the seller (e.g., a bank selling loans, financial institution selling debt, securities or derivatives or a public or private company or individual selling debt or real-estate) will receive for selling its assets of value on the online platform or application.

For the purposes of this disclosure, cash or cash equivalents shall mean, any form of payment, by any means, including but not limited to electronic, which, like cash, once it is received, it is in the custody and control of the party that received it and cannot be reversed or taken back by the sender of the payment or the platform or application that sent it.

### BACKGROUND

Many electronic platforms exist, both online and offline, to purchase assets of value electronically. Currently existing and prior method for purchasing an asset of value online through electronic means, including but not limited to, real estate auction online platforms, use methods that are advantageous to the potential purchaser and to the detriment of the seller that often create issues and prevent the item of value from being sold efficiently and to the highest bidder.

One common method used is to require a potential purchaser to provide their credit card information during the registration or bidding process. The online platform or application, which, for the purpose of this disclosure, is intended to include any and all electronic methods for facilitating sale of one or more assets of value, either places a hold on the funds at the bid deposit amount prior to the event deadline, or they place a hold on the funds after the chosen or (automatically or manually) selected potential purchaser of the asset of value is chosen or selected.

Unfortunately, prospective purchasers, after making an offer or bidding on one or more asset of value, can easily decide to not follow through with the transaction and dispute/challenge the hold or charge placed on their credit card with their credit card merchant and attempt to not purchase the asset of value without any real consequence for the prospective purchaser. As a result of this practice where the highest potential purchaser does not follow through, which happens often, significantly fewer assets of value are actually sold and the seller of the asset of value does not receive the maximum amount of money or the benefits, efficiency and scalability of the online platform or application that avoids potential purchaser from being able to re-trade their pricing and closing terms, or not proceed with the terms of a purchase transaction they agreed to without penalty or consequences.

While many groups have tried to mitigate or lessen the risk that the sale will fall through (i.e., fallout risk) by having the prospective purchaser (and sometimes sellers of an asset of value) execute agreements and agree to terms and conditions indicating they will be liable monetarily or punished in some way (e.g., being banned or removed from the online platform or required to pay their deposit in a different way or in advance for that or their next purchase) if they do not satisfy the terms of the purchase agreement or the platform's or application's terms and conditions, this often does not deter them from doing so again. More importantly, these agreements and/or terms and conditions will prevent some prospective purchasers from completing their registration, thereby reducing the number of prospective purchasers and not maximizing the amount of money the seller of the asset of value (e.g., bank or lender) will receive from sale of the asset to the broadest base of vetted and serious purchasers.

In fact, prospective sellers are disincentivized from listing and selling their property and using the currently available online platforms that do not hold prospective purchasers that submit bad faith offers accountable and punish them. Prospective purchasers that submit offers in bad faith and try to re-trade or re-negotiate after their offer has been accepted are not held accountable or punished by the online platform because the platform does not have possession or control of a cash or cash equivalent deposit from the prospective purchaser.

Accordingly, current methods and systems shown and described in the prior art, reward prospective purchasers that submit an offer in bad faith because it allows the bad faith prospective purchaser to lock a seller into to a forced re-negotiation of terms (usually price) after the bad faith offer was accepted, because the platform has no cash or cash equivalent deposit from the prospective purchaser that it can use to force the prospective purchaser to comply with the terms of the submitted offer that the seller has accepted.

Other existing online platforms and applications require a potential purchaser to manually send, typically by wire transfer, a cash or cash equivalent deposit directly to the online platform or application or to the trust account or a third-party escrow company prior to allowing them to make an offer to purchase any asset of value. While this may avoid or reduce purchase transactions from falling out or not completing the sale, presumably because the prospective purchaser has paid a (possibly non-refundable) deposit that the online platform or application has control of and the potential purchaser proceeds, at least in part, because he or she does not want to lose their deposit, it is difficult and expensive for the online platform or application to implement and also reduced the number of total qualified vetted potential purchasers of the one or more assets of value. Among other things, the cost, training and maintenance of employees for the platform, application and seller to accomplish this manually and the ability for human error to cause errors and loss of funds, adds significant costs and the possibility for errors that would result in losses to the platform, application and/or prospect purchasers and sellers of the assets of value.

Additionally, requiring the potential purchaser to manually send a cash or cash equivalent deposit will result in significantly less potential purchasers completing the registration process and making an offer or bid on the asset of value. As a result, the seller of the asset of value will have less vetted and qualified potential purchasers making offers or bidding and the sellers will receive less than the highest price and best terms for selling their asset of value.

Among other things, the present disclosure provides various benefits, including that prospective purchasers do not need to put in the time, effort and often money (e.g., banking, wire and platform or application fees) to manually send a deposit. Avoiding this requirement increases and maximizes the amount of legitimate and real prospective purchasers and maximizes the price that the seller of the asset of value will receive, while removing the inconvenience of manually sending a cash or cash equivalent deposit. This not only improves costs and efficiencies for the seller of the asset, prospective purchasers and the online platform or application, but it also allows both the potential purchaser and seller of the asset of value to scale and sell or buy dramatically more assets than they would be able to do otherwise.

In other existing online platforms or applications, a deposit of any kind is not required at all from the potential purchasers, which often means they are relying only on the potential purchaser providing some evidence of having funds available, often referred to in the industry as “proof of funds.” Proof of funds are provided by the prospective purchaser to the platform, application or seller to ensure the prospective purchaser has the liquidity or cash to purchase the asset of value if they are the selected or chosen to purchase the asset of value.

The method of relying on “proof of funds” has the same disadvantages and drawbacks of the other methods described above and herein where the prospective purchaser has not given control and custody of their deposit to the online platform or application or seller of the asset. Accordingly, this prospective purchaser can, and often does, not follow through with the purchase of the asset of value after making an offer, with little to no consequence to the potential purchaser. Additionally, this method, like the other described above, allows those potential purchasers that don't actually have the money, ability or sincere intent to complete the purchase of the asset of value to make an offer to purchase the asset of value and likely try to re-trade/re-negotiate one or more terms of the agreement and not complete the purchase. This results in a dramatic increase in the amount of assets of value that do not sell because the potential purchaser does not take the necessary steps to complete the transaction possibly because they did not have the funds or actual intent to complete the purchase.

Large commercial real estate sales and other companies have tried to mitigate the issues and drawbacks of the current methods by using their own or a third-party escrow company to address the issue of fallout and manually handling wires, at incredible cost and difficulty and have seen a significant number of prospective purchasers not complete the registration process in order to make an offer on an asset of value.

Another serious problem with current online methods and systems, is that the sellers of the assets are often banks, other financial institutions and larger companies that have extensive regulatory and approval processes. The institutions selling an asset of value often make decisions for each asset being sold by committee and various approvals are required to sell a particular asset, which takes a significant amount of time and resources of the company. With current methods and systems for selling assets allowing prospective purchasers to re-trade and re-negotiate an accepted offer without accountability or penalty, dramatically increases the time, labor and inconvenience personnel at the institutions experience when having to accept another offer and obtain all the necessary approvals again to sell the asset of value.

Unfortunately, all of the prior methods of selling an asset of value have various disadvantages and create a variety of serious issues and problems, some of which are disclosed and elaborated herein. The drawbacks of the current methods create significant risk and issues for both the online platform or application for the seller of the one or more assets of value, which is often a conservative bank, lender or regulated financial institution. Every seller of an asset of value values and desires both (1) certainty of execution and sale and (2) maximizing the amount of money they will receive for selling the asset of value. The methods and systems of the present disclosure provide systems and methods that, among other things, drastically increases the certainty and execution of sale of the assets of value and (2) obtains the highest price and best terms that the seller obtains by maximizing the number of serious, committed potential purchasers, while discouraging the problems and behaviors of buyers which are common with platforms which typically utilize the current methods of credit card deposits and manual wire transfers.

Among other things, the method and systems of the present disclosure provide improved methods and systems that do not give prospective purchasers the unfair advantage of being able to back out of a purchase transaction, with little to no consequence, resulting in increased deal fallout and a bad experience for both the potential purchasers and sellers of the one or more assets of value, and damage to the brand and reputation of the online platform. In doing so, the systems and methods of the present disclosure dramatically improve both the experience and results that those potential purchasers and sellers of one or more assets of value experience when selling or purchasing an asset of value. Importantly, they also provide sellers of the assets of value to increase the productivity of their staff and be able to scale sales of their assets of value.

Accordingly, there exists a need for methods and systems that solve most if not all of the disadvantages and drawbacks of the current methods and systems, and also dramatically improves efficiency, uses specific process, timing and deadlines to always keep the purchase transaction moving forward, allows for scalability and integration with multiple marketplaces and provides various other benefits and advantages described and elaborated herein. The methods and systems of the present disclosure provide these and various other benefits and advantages.

### SUMMARY OF THE INVENTION

The present disclosure includes methods and related systems for obtaining cash or cash equivalent deposits from one or more potential purchasers of one or more assets of value using an online platform or application.

In at least one embodiment, the method comprises (1) entering into an agreement with one or more sellers of one or more assets of value to facilitate the sale of the one or more assets of value, (2) entering into an agreement with one or more potential purchasers of the one or more assets of value where the one or more potential purchasers agree to pay a cash or cash equivalent deposit to have the ability and/or right to purchase one or more assets of value and agree to forfeit at least a portion of the cash or cash equivalent deposit that the one or more potential purchasers paid if any of the one or more purchasers that paid a cash or cash equivalent deposit do not satisfy the terms of the agreement entered into to have the ability and/or right to purchase one or more assets of value, (3) receiving from the one or more potential purchasers a cash or cash equivalent deposit to purchase one or more assets of value, (4) returning the cash or cash equivalent deposit received from the one or more purchasers to the one or more purchasers that were not selected to purchase the one or more assets of value and (5) returning the cash or cash equivalent deposit to the one or more purchasers from which it was received when the seller of the asset of value does not satisfy the terms of the agreement with the seller of the asset of value.

In at least one aspect of one embodiment of the present disclosure, the one or more sellers of one or more assets of value agree to share at least a portion of the cash or cash equivalent deposit obtained from the one or more potential purchasers with the online platform or application.

In at least one aspect of one embodiment of the present disclosure, the methods and associated systems also includes returning the cash or cash equivalent deposit received from the one or more purchasers to the one or more purchasers that were not selected to purchase the one or more assets of value includes returning at least a portion of the cash or cash equivalent deposit to the one or more purchasers.

In at least one aspect of one embodiment of the present disclosure, the cash or cash equivalent deposit paid by the one or more potential purchasers is held or controlled by an entity, platform, application or individual that entered into the agreement with the one or more potential purchasers.

In at least one aspect of one embodiment of the present disclosure, the cash or cash equivalent deposit paid by the one or more potential purchasers is held or controlled by the one or more sellers of the one or more assets or the one or more potential purchasers of the one or more assets of value.

In at least one aspect of one embodiment of the present disclosure, the cash or cash equivalent deposit to purchase the one or more assets of value is received before the one or more of the one or more potential purchasers of a particular asset of value are chosen or identified.

In at least one aspect of one embodiment of the present disclosure, the cash or cash equivalent deposit to purchase the one or more assets of value is requested from the one or more potential purchasers shortly after the one or more potential purchasers makes an offer to purchase the one or more assets of value.

In at least one aspect of one embodiment of the present disclosure, the method additionally comprises receiving bank account or payment information from the one or more potential purchaser of the one or more assets of value and receiving a wire, ACH or bank to bank payment as the cash or cash equivalent deposit from the one or more purchasers.

In another embodiment of the present disclosure, the method comprises (1) entering into an agreement with one or more sellers of one or more assets of value to facilitate the sale of the one or more assets of value, (2) entering into an agreement with one or more potential purchasers of the one or more assets of value where the one of more potential purchasers agree to pay a cash or cash equivalent deposit to have the ability and/or right to purchase one or more assets of value and agree to forfeit at least a portion of the cash or cash equivalent deposit that the one or more potential purchasers paid if any of the one or more purchasers that paid a cash or cash equivalent deposit do not satisfy the terms of the agreement entered into regarding purchase of the asset of value (3) receiving from the one or more potential purchasers a cash or cash equivalent deposit to purchase one or more assets of value, (4) returning the cash or cash equivalent deposit received from the one or more purchasers to the one or more purchasers that were not selected to purchase the one or more assets of value and (5) returning the cash or cash equivalent deposit to the one or more purchasers from which it was received when the seller of the asset of value does not satisfy the terms of the agreement with the seller of the asset of value.

In at least one aspect of at least one embodiment of the present disclosure, the one or more sellers of one or more assets of value agree to share at least a portion of the cash or cash equivalent deposit obtained from the one or more potential purchasers with the online platform or application.

In at least one aspect of at least one embodiment of the present disclosure, the one or more sellers of one or more assets of value hold and retain the entire deposit, which is processed for payment through the online platform. The lender agrees to pay a subscription fee for the usage of the platform and processing of the payments as they coincide with selling one or more assets of value on the online platform to one or more potential purchasers.

In at least one aspect of at least one embodiment of the present disclosure, returning the cash or cash equivalent deposit received from the one or more purchasers to the one or more purchasers that were not selected to purchase the one or more assets of value includes returning at least a portion of the cash or cash equivalent deposit to the one or more purchasers.

In at least one aspect of at least one embodiment of the present disclosure, the cash or cash equivalent deposit paid by the one or more potential purchasers is held or controlled by an entity, platform, application or individual that entered into the agreement with the one or more potential purchasers.

In at least one aspect of at least one embodiment of the present disclosure, the cash or cash equivalent deposit paid by the one or more potential purchasers is held or controlled by an entity, platform, application or individual that is not either the one or more sellers of the one or more assets or the potential purchasers of the one or more assets of value.

In at least one aspect of at least one embodiment of the present disclosure, the cash or cash equivalent deposit to purchase the one or more assets of value is received before the one or more potential purchasers of a particular asset of value are chosen or identified.

In at least one aspect of at least one embodiment of the present disclosure, the cash or cash equivalent deposit to purchase the one or more assets of value is requested from the one or more potential purchasers shortly after the one or more potential purchasers makes an offer to purchase the one or more assets of value.

In at least one aspect of one embodiment of the present disclosure, a method using an online platform or application for online purchase transactions for assets of values is provided.

In at least one aspect of one embodiment, the method requires the one or more prospective purchasers of the one or more assets of value enter into an agreement, oral or written, and the one or more prospective purchasers agree to provide a deposit prior or concurrent to being able to make an offer on one or more assets of value being sold.

In at least one aspect of one embodiment, the one or more prospective purchasers agree to provide a cash or cash equivalent deposit.

In at least one aspect of one embodiment, the cash or cash equivalent deposits obtained by one or more prospective purchasers is deposited into a trust account or escrow account.

In another embodiment of the present disclosure, a system is provided. The system comprises (1) a memory comprising computer-executable instructions; (2) one or more processors in communication with the memory and configured to access the memory and execute the computer-executable instructions to at least (a) generate information or instructions regarding one or more sellers or one or more assets of value that one or more sellers' desire to sell, (b) generate information or instructions regarding one or more potential purchasers or the one or more assets of value that the one or more potential purchasers' desire to purchase, (c) generate information or instruction regarding the one or more potential purchasers agree to pay or paying a cash or cash equivalent deposit to have the ability and/or right to purchase one or more assets of value, (d) generating information or instructions regarding the cash or cash equivalent deposit that the one or more potential purchasers paid, (e) generating information or instructions regarding the transfer of at least a portion of the cash or cash equivalent deposit paid by the one or more potential purchaser, (f) generating information or instructions regarding or receiving instructions from the one or more potential purchasers to purchase one or more assets of value, (g) generating information or instructions regarding the cash or cash equivalent deposit received from the one or more purchasers that is to be returned to the one or more purchasers that were not selected to purchase the one or more assets of value; and (h) generating information or instructions regarding returning the cash or cash equivalent deposit to the one or more purchasers from which it was received when and if the seller of the asset of value does not satisfy the terms of the agreement with the seller of the asset of value.

In another embodiment of the present disclosure, generating information or instructions regarding returning the cash or cash equivalent deposit received from the one or more purchasers to the one or more purchasers that were not selected to purchase the one or more assets of value includes providing information or instructions regarding returning at least a portion of the cash or cash equivalent deposit to the one or more purchasers.

In another embodiment of the present disclosure, generating information or instructions regarding the cash or cash equivalent deposit paid by the one or more potential purchasers is held or controlled by the system.

In another embodiment of the present disclosure, generating information or instructions regarding the cash or cash equivalent deposit paid by the one or more potential purchasers is determined or controlled by the system.

In another embodiment of the present disclosure, the information or instructions regarding the cash or cash equivalent deposit to purchase the one or more assets of value is received by the system before the one or more of the one or more potential purchasers of a particular asset of value are chosen or identified.

In another embodiment of the present disclosure, the information or instructions regarding the cash or cash equivalent deposit to purchase the one or more assets of value is requested by the system from the one or more potential purchasers shortly after the one or more potential purchasers makes an offer to purchase the one or more assets of value.

In another embodiment or aspect of the present disclosure, the system generates information or instructions regarding receiving bank account or payment information from the one or more potential purchaser of the one or more assets of value and/or receiving a wire, ACH or bank to bank payment as the cash or cash equivalent deposit from the one or more purchasers.

In another embodiment of the present disclosure, (1) a memory comprising computer-executable instructions, (2) one or more processors in communication with the memory and configured to access the memory and execute the computer-executable instructions to at least: (a) generating information or instructions regarding entering into an agreement with one or more sellers of one or more assets of value to facilitate the sale of the one or more assets of value, (b) generating information or instructions regarding one or more potential purchasers of the one or more assets of value paying a cash or cash equivalent deposit, (c) generating information or instructions regarding the one or more potential purchasers the ability and/or right to purchase one or more assets of value; (d) generating information or instructions regarding the one or more potential purchasers forfeiting at least a portion of the cash or cash equivalent deposit that the one or more potential purchasers paid, (e) generating information or instructions regarding the cash or cash equivalent deposit received from the one or more purchasers (f) generating information or instructions regarding returning the cash or cash equivalent deposit received from the one or more purchasers that were not selected to purchase the one or more assets of value to the one or more purchasers that were not selected; (g) generating information or instruction regarding returning the cash or cash equivalent deposit to the one or more purchasers from which it was received if and when the seller of the asset of value does not satisfy the terms of the agreement with the seller of the asset of value and (h) generating information or instructions to share at least a portion of the cash or cash equivalent deposit obtained from the one or more potential purchasers with the system, platform or application.

In another embodiment of the present disclosure, a system is provided, comprising a memory comprising computer-executable instructions and one or more processors in communication with the memory and configured to access the memory and execute the computer-executable instructions to at least: (a) generating information or instructions regarding entering into an agreement with one or more sellers of one or more assets of value to facilitate the sale of the one or more assets of value, (b) generating information or instructions regarding entering into an agreement with one or more potential purchasers of the one or more assets of value, (c) generating information or instructions regarding the one of more potential purchasers agree to pay a cash or cash equivalent deposit to have the ability and/or right to purchase one or more assets of value, (d) generating information or instructions regarding the one or more potential purchasers agree to forfeit at least a portion of the cash or cash equivalent deposit that the one or more potential purchasers paid, (e) generating information or instructions regarding receiving from the one or more potential purchasers a cash or cash equivalent deposit to purchase one or more assets of value, (f) generating information or instructions regarding returning the cash or cash equivalent deposit received from the one or more purchasers to the one or more purchasers that were not selected to purchase the one or more assets of value; (g) generating information or instructions regarding returning the cash or cash equivalent deposit to the one or more purchasers from which it was received when the seller of the asset of value does not satisfy the terms of the agreement with the seller of the asset of value, and (h) generating information or instructions regarding the one or more sellers of one or more assets of value paying the system, online platform or application a fee if the seller's one or more assets of value are sold to the one or purchasers on the system, online platform or application.

In another embodiment of the present disclosure, the system further comprises generating information or instructions regarding the one or more sellers of one or more assets of value being able to accept or reject an offer from one or more prospective purchasers of an asset of value using the system, online platform or application.

In another embodiment of the present disclosure, the system further comprises generating information or instruction regarding the one or more sellers of one or more assets rejecting an offer from the one or more prospective purchasers.

In another embodiment of the present disclosure, the system automatically returns the cash or cash equivalent deposit to the prospective purchaser whose offer was rejected by the one or more sellers of an asset of value.

### BRIEF DESCRIPTION OF THE DRAWINGS

The foregoing and other objects, aspects, features, and advantages of the present disclosure will become more apparent and better understood by referring to the following description taken in conjunction with the accompanying drawings, in which:

FIG. 1 is a flow chart comparison showing two different methods that involve receiving a cash or cash equivalent deposit and a method in which a credit card charge or hold deposit is received.

FIG. 2 is a flow chart comparison showing two different methods that involve a cash or cash equivalent deposit being obtained and a manual wire deposit being obtained.

FIG. 3 is a flow chart of a seller asset creation process in accordance with at least one embodiment of the present disclosure.

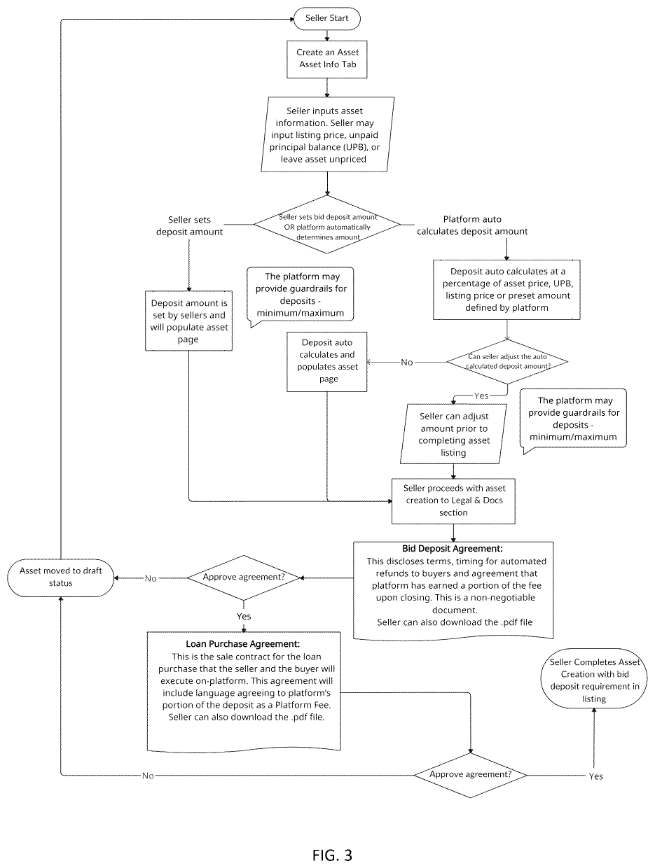

FIG. 4 is a flow chart of a potential purchaser registration process in accordance with at least one embodiment of the present disclosure.

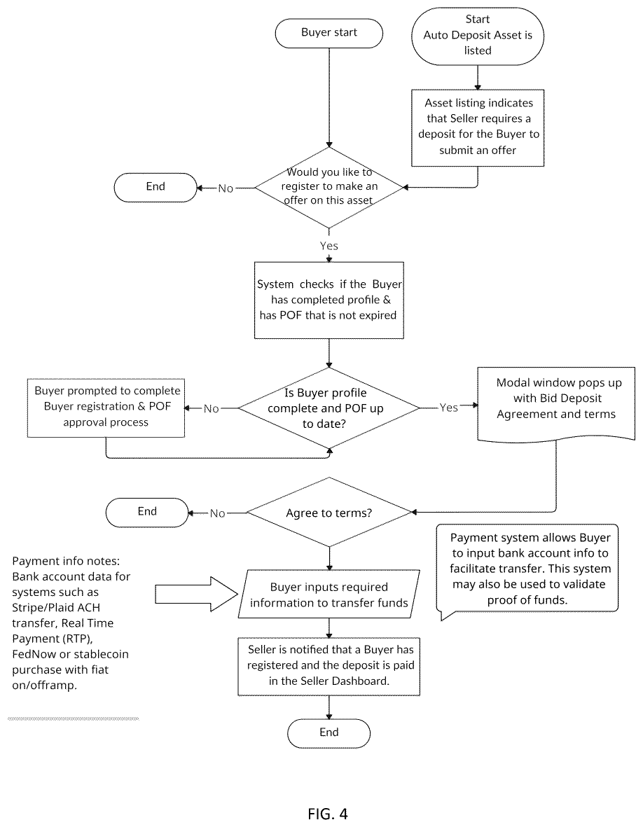

FIG. 5 is a flow chart of an offer and a deposit in accordance with at least one embodiment of the present disclosure.

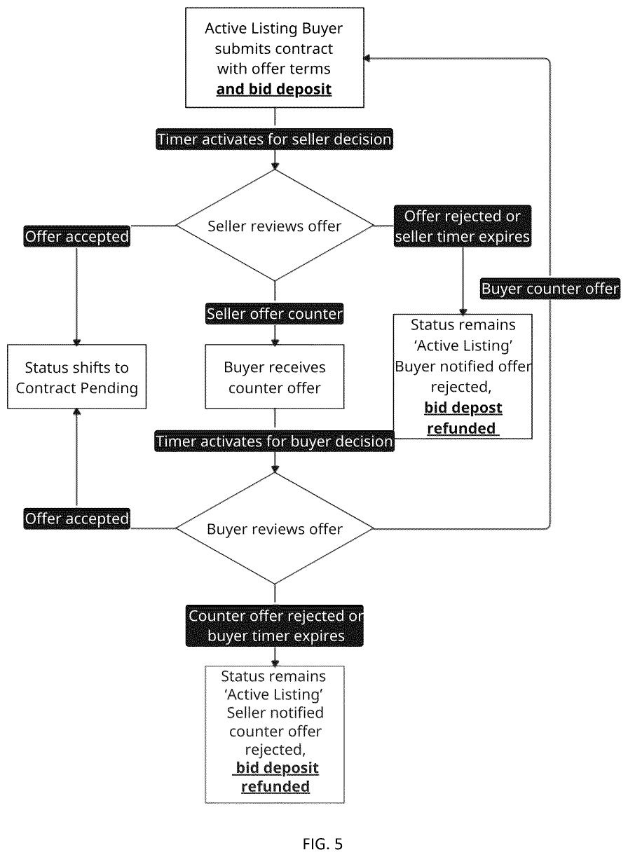

FIG. 6 is a flow chart of an offer acceptance and agreement generation in accordance with at least one embodiment of the present disclosure.

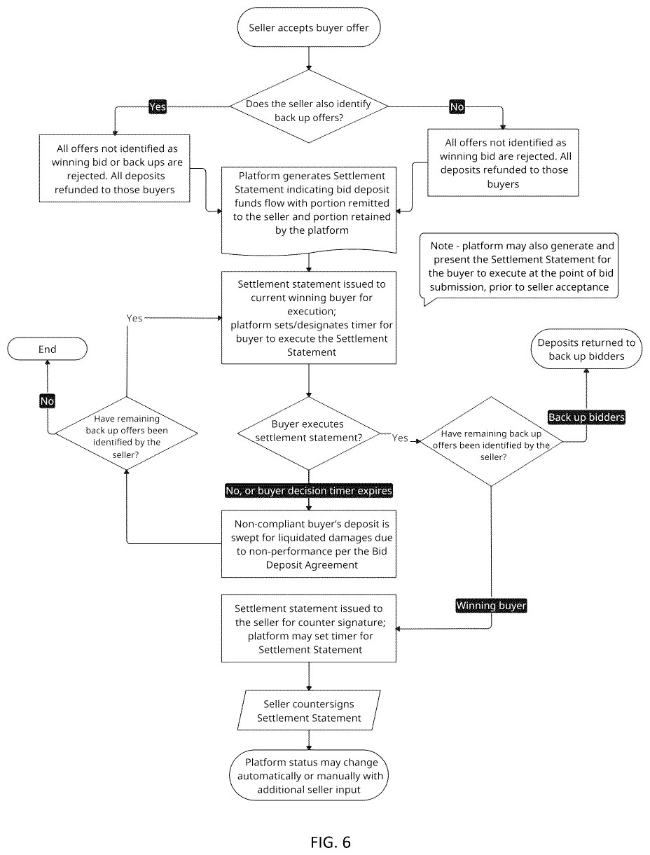

FIG. 7 is a flow chart of a bidder registration and an agreement generation for auction events in accordance with at least one embodiment of the present disclosure.

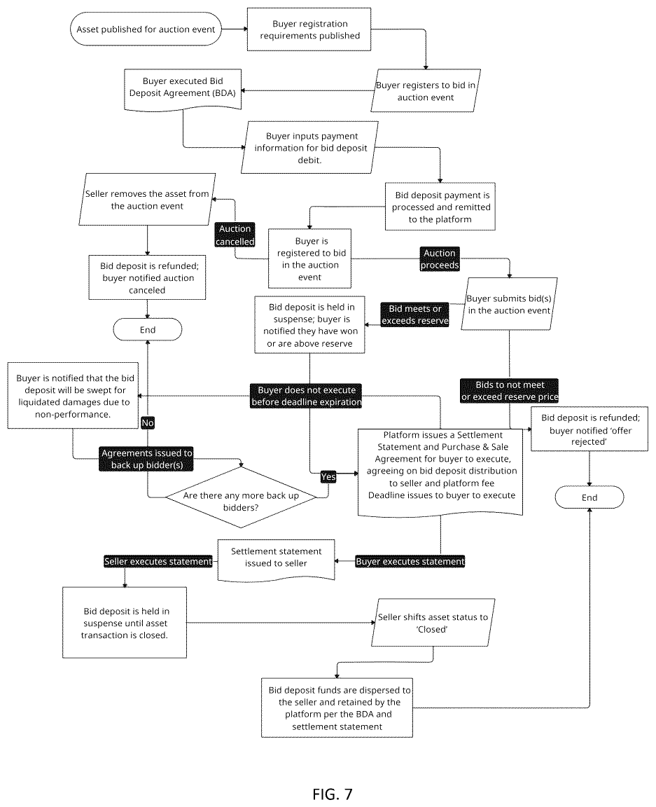

FIG. 8 is a flow chart of a bidder registration and agreement generation for active listings that have no deadline for offers and call for offer that have a deadline for offers, in accordance with at least one embodiment of the present disclosure.

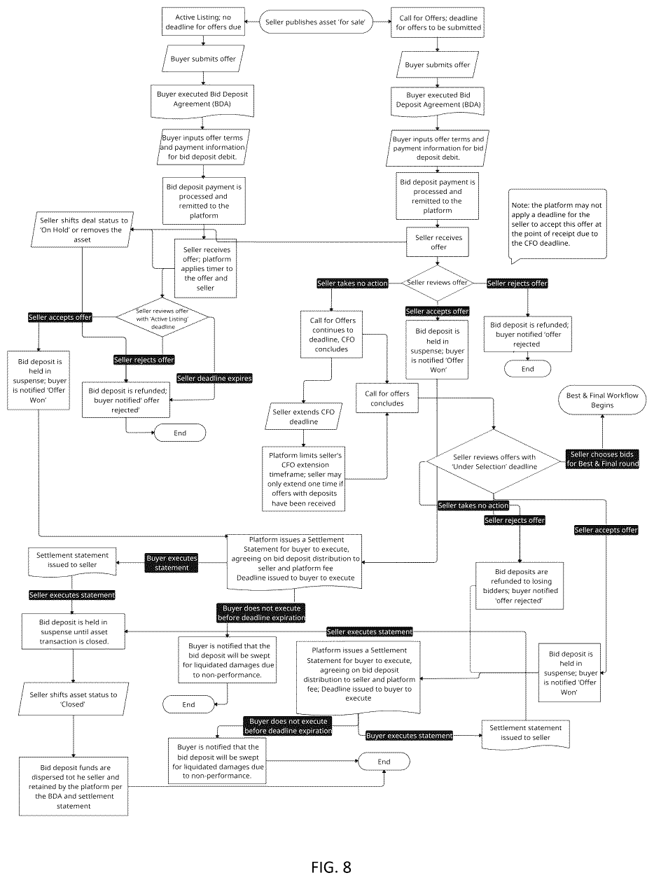

FIG. 9 is a flow chart of a closing transaction in accordance with at least one embodiment of the present disclosure.

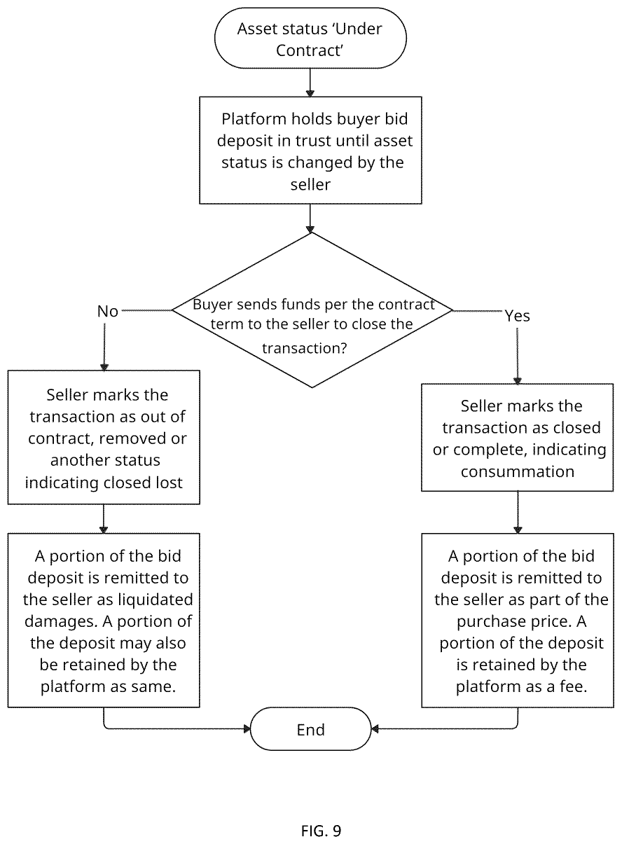

FIG. 10 is a flow chart of a funds flow variation when the platform immediately remits a portion of the bid deposit to the seller or an escrow or closing company upon acceptance of the received offer.

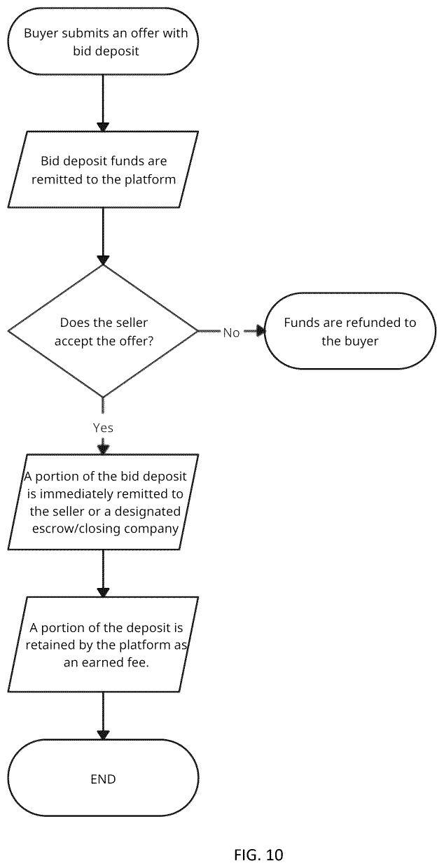

FIG. 11 is a flow chart of a funds flow variation when the platform processes payments on behalf of the seller, and immediately remits the entire bid deposit to the seller or an escrow or closing company upon acceptance of the received offer.

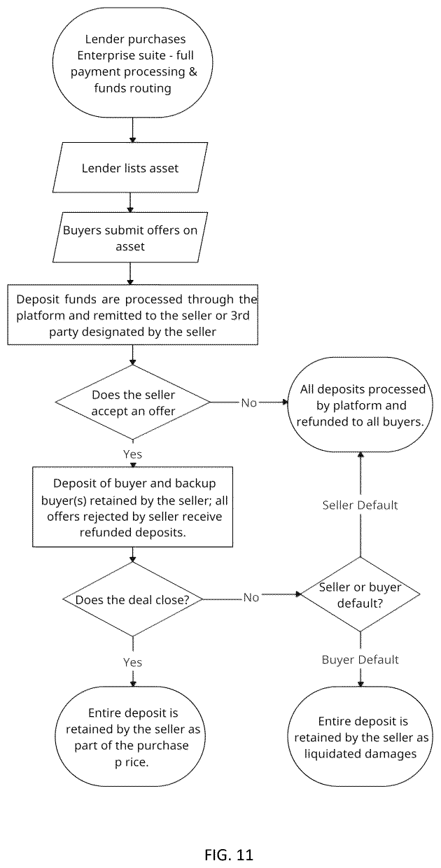

FIG. 12 is a flow chart showing one embodiment of the present disclosure

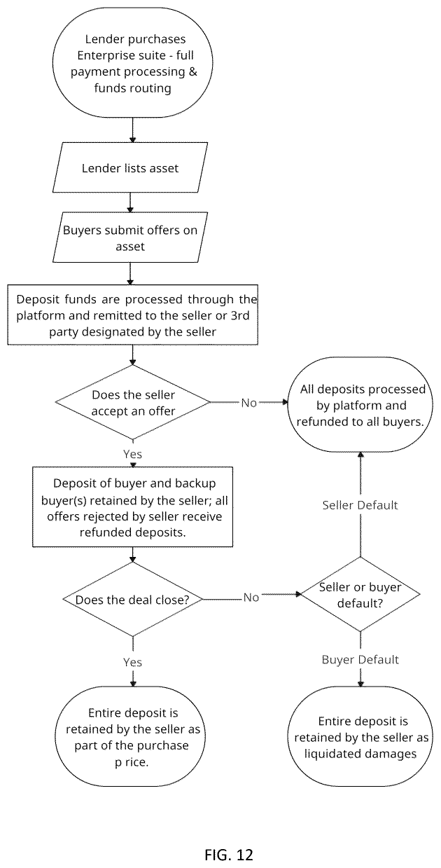

### DETAILED DESCRIPTION OF THE INVENTION

The following description and details are not to be taken in a limiting sense, but is made merely for the purpose of illustrating the general principles of the inventions disclosed herein. Various inventive features are described below that can each be used independently of one another or in combination with other features of the methods and compositions disclosed herein.

In at least one embodiment of the present disclosure described herein, methods and systems using an online purchasing platform or applications, collects a cash or cash equivalent payment or deposit from one or more prospective purchasers that want to purchase one or more assets of value, in a marketed online transaction, as a condition of the one or more prospective purchasers submitting a bid or an offer to purchase the one or more assets of value from the seller of those assets.

In at least one aspect of at least one embodiment of the present disclosure, the prospective purchaser enters into an agreement prior to or concurrently with submitting or sending a deposit prior to being able to make an offer to purchase one or more assets of value.

In an aspect of at least one embodiment of the present disclosure, the potential purchaser executes an agreement (e.g., Bid Deposit Agreement) that includes one or more terms that (1) require the potential purchaser confirm they reviewed the asset details and terms of the offer for sale of the asset of value and (2) if the potential purchaser submits an offer to purchase an asset of value and if that offer is accepted, the potential purchaser agrees to abide by the all the terms of the offer submitted by the potential purchase or release, lose or forfeit part to all of the deposit that the potential purchaser paid or agreed to pay.

In another embodiment of at least one embodiment of the present disclosure, the agreement entered into by the one or more potential purchasers allows the seller of the asset of value or the online platform or application to keep or transfer the deposit of one or more potential purchasers if the prospective purchaser does not move forward with or satisfy the terms of the sale of the one or more assets of value.

In an aspect of at least one embodiment of the present disclosure, the one or more potential purchaser agrees that the seller of the asset of value or the online platform or application may keep or transfer the deposit of the one or more potential purchasers as liquidated damages.

In an aspect of at least one embodiment of the present disclosure, the online platform or application can push/pull cash transfers from one or more prospective purchasers for an unlimited number of offers or bids from the one or more prospective purchasers automatically.

In an aspect of at least one embodiment of the present disclosure, the online platform or application refunds the deposits of the one or more prospective purchasers automatically if the seller of the asset of value does not accept that prospective purchaser's offer.

In an aspect of at least one embodiment of the present disclosure, if an offer or bid is accepted automatically based on rules of guidelines or by the seller or online platform or application, the deposit for the selected offer or bid is held in a trust account controlled by the online platform or application until the transaction is closed or some other event triggering return of the deposit occurs.

In an aspect of at least one embodiment of the present disclosure, the seller of one or more items of value can request or cause part to all of the deposit received from the selected or chosen prospective purchaser from the online platform or application trust account using the controls provided to the seller on the online platform or application, which will be applied as part of the winning bidder's total purchase price.

In an aspect of at least one embodiment of the present disclosure, at least a portion of the deposit received by the online platform or application from the one or more prospective purchasers is kept by the online platform or application, as a fee.

The methods and associated systems disclosed herein can be used for any online transaction where both parties, potential purchaser and seller, want to or are required to enter into a contract to consummate the purchase transaction of an asset of value. This is most common for larger dollar transactions and/or transactions where specific performance and various guarantees (e.g., clear and marketable title) are promised by one party to the transaction and representations and warranties from both parties are desired or required.

The method and systems of the present disclosure can be used on, for example and not by way of limitation, on sales, and/or origination, of loans and debts, homes, commercial real estate, cars, boats, fine art and any asset that has value. The methods and associated systems of the present disclosure can also be used for mortgage loan origination, legal fees, contractor services and other matters having value to the parties entering into contract with the online platform or application. Furthermore, the method and associated systems can be used in other transactions where good faith deposits are required for one or both parties to expend time and resources to prepare for transaction consummation where multiple quotes are provided, received and reviewed by a potential purchaser and seller.

As one example of how one of the methods and/or systems of the present disclosure could be practiced, a seller of an asset of value worth $1,000,000 can enter into an agreement to sell the asset on an online platform or application and agree that the one or more potential purchasers must agree to pay a $5,000 deposit before the one or more potential purchasers can submit an offer on the asset. For example, if 36 unique potential purchasers enter into an agreement as described above and herein and submit different offers or bids on the asset of value worth $1,000,000. In an aspect of at least one embodiment of this disclosure, $180,000 ($5,000×36 unique potential purchasers) offer or bid deposits are collected and received from the 36 potential purchasers, which allow them to submit their offers.

In at least one aspect of one embodiment of the present disclosure, the seller selects one or more offers or bids (in one embodiment, one offer or bid is selected as the winner, and 2 other potential purchasers are selected or automatically chosen as back-up potential purchasers) to sell the asset of value to. When the seller of the asset of value selects one or more offers or bids, the deposit for all of the potential purchasers that were not selected are automatically returned to the potential purchaser who's offer or bid was not selected. In the case above, if one offer was selected a winner and 2 others were back-up potential purchasers, $165,000 in deposits ($5,000×33) is automatically refunded to each individual potential purchaser that was not chosen, and $15,000 ($5,000×3) is held in the trust account in the control of the online platform or application.

In at least one aspect of one embodiment of the present disclosure, when the seller(s) complete any negotiations and mutually execute a purchase agreement with the selected or chosen potential purchasers, the status of the asset of value being sold is changed to indicate the asset is under contract.

In at least one aspect of one embodiment of the present disclosure, the received deposits of any back-up potential purchasers are automatically refunded, and the selected or chosen potential purchaser's deposit is held until the seller indicates that the status of the transaction is completed or closed and the asset of value as been sold by the seller.

In at least one aspect of one embodiment of the present disclosure, at least part of the deposit and any other funds received from the potential purchaser are then dispersed to the seller and part of those funds are held by the online platform or application as a fee for use of the online platform or application.

The methods and associated systems of the present disclosure provide benefits and advantages for both the one or more sellers of an asset of value and for the one or more purchasers of an asset of value. As an example, and not by way of limitation, for the one or more sellers, the methods and systems disclosed herein increases surety of execution and maximizes the amount of money the one or more sellers of an asset of value will receive for selling their asset of value. Additionally, by receiving (and possibly controlling) an actual cash deposit and a guarantee of specific performance from the potential purchaser if the potential purchaser's offer is accepted, the seller is in a more secure position when accepting an offer from the one or more potential purchaser's, all of which have paid an actual cash or cash equivalent deposit and, will lose some to all of their paid cash or cash equivalent deposit, if they do not complete the transaction.

Using the methods and systems described herein, the one or more sellers of an asset of value will not expend valuable time and money to sell to a potential purchaser that is not qualified or serious. While some contracts require an earnest money deposit, or EMD, to be provided from the one or more potential purchasers to the seller or an escrow company to avoid deal fallout and the sales transaction not being completed, the EMD is typical not provided until the one or more potential purchasers and the one or more sellers of an asset of value have negotiated and agreed on the terms of a purchase contract and that contract is mutually executed by both parties, after the buyer's offer has been submitted and accepted by the seller. The methods and systems of at least some of the embodiments disclosed herein require a cash or cash equivalent deposit to be obtained from the potential purchaser before the purchase contract is negotiated or signed, ensuring all parties are negotiating in good faith with the full intention to consummate the purchase transaction.

Among other things, the methods and systems of the present disclosure avoid potential purchasers who are not qualified, not serious, looking to waste time or try to game the system or submit an offer in bad faith. It is very common for potential purchasers to attempt to circumvent an online bidding process by submitting a bid that is much higher than what they intend on paying as a purchase price and then trying to renegotiate the price before the final contract is signed and the purchase agreement terms are agreed upon (and any EMD is sent to the seller or escrow). The practice is extremely common in the bidding industry that a potential purchaser that tries to circumvent an online bidding process in this way is often referred to as someone who “re-trades.” When this happens, often occurring in online transactions, it is commonly referred to as a ‘fall out.” When potential purchasers guarantee that they will follow through on the terms of their offer or bid or lose the cash or cash equivalent deposit that they paid, all participating potential purchasers can be assured they have a fair chance of purchasing the asset of value when they make their best offer or bid on an even playing field with all the other potential purchasers and sellers of the assets of value obtain the highest and best price for the asset they are selling by virtue of having the maximum number of vetted and serious potential purchasers making offers or bidding to purchase the asset of value.

Fall out is a major problem for any online platform or application's integrity as a transaction marketplace since it damages the platform's brand with the sellers of an asset of value as a place where sellers can have surety of close and be confident that they can reliably consummate and complete the purchase transaction. An additional benefit the methods and systems disclosed herein avoids sellers expending significant time and resources to determine a potential purchaser's genuine desire and intent to pursue an asset of value and the pricing that a particular potential purchaser is willing to pay for the specific asset. If sellers believe the online platform or application is a waste of time and if potential purchasers' honest efforts to purchase assets do not yield results, sellers and/or potential purchasers will be inclined to cease using to the online platform or application for purchasing and/or selling one or more assets of value, or also circumvent the system, further damaging the brand and integrity.

Another benefit and advantage of the methods and systems disclosed herein, is issues related to using credit cards to purchase one or more assets of value is avoided. Credit card transactions involve a third-party payment processor that allows a potential purchaser to dispute a transaction prior to the purchase contract being signed (and possibly the EMD received) resulting in both the online platform or application and the seller being left without a bona-fide purchaser, deposit or immediate recourse that does not involve litigation or a further dispute with the potential purchaser. Potential purchasers are well aware of the shortcoming of a credit card transaction and disputing credit card holds and transactions to allow potential purchasers to renegotiate the price before signing a purchase and sale contract. Online platforms and applications will often contest the disputes with the credit card company. However, the process takes resources and a significant amount of time, potentially taking more than 120 days to complete and the credit card company often sides with their client, the potential purchaser. This considerable amount of time, effort and money expended to deal with credit card disputes often result in more fall out and damage to the online platform or application's brand.

Another issue related to using credit cards is one or more online platforms and applications wait until a winner is identified to place a hold on funds but then issues arise when a potential purchaser or bidder does not have sufficient funds available in their credit card or line to cover the deposit hold to purchase the one or more assets of value. To address the issue, online platforms or applications limit the hold amount, which often requires setting the bid deposit amounts far too low compared to the transaction size. As a result, the deposit is so small that the potential purchaser is less inclined to commit to the potential purchase and does not ensure certainty of execution to purchase one or more assets of value. As an example, if a potential purchaser is purchasing an asset valued at $10,000,000 but wishes to renegotiate pricing, they are far less likely to forfeit a $100,000 bid deposit than if the online platform or application limits the bid deposit amount to $10,000.

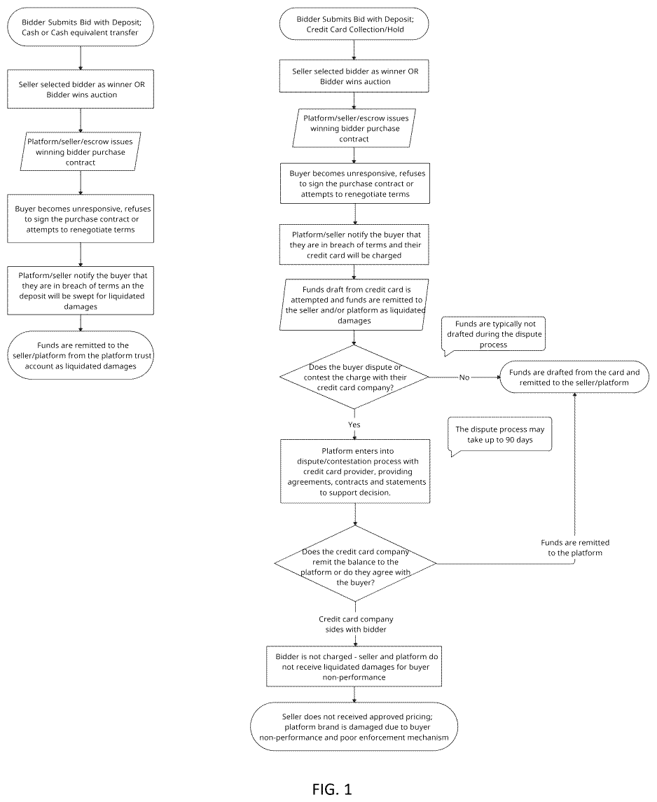

As shown in FIG. 1, a method or system or obtaining a cash or cash equivalent deposit as part of a purchase and sale transaction is a more efficient and secure method of obtaining a deposit than using a third-party credit card. In one or more embodiments of the present disclosure, the cash or cash equivalent deposit paid by the one or more potential purchasers is held or controlled by an online platform or application therefore if a potential purchaser defaults on the terms of the agreement, at least a portion of the cash or cash equivalent deposit is retained by the online platform or application and/or the seller of asset of value for liquidated damages.

A manual wire deposit, a cash or cash equivalent paid by the potential purchaser outside the online platform or application, is transferred to the online platform or application providing the platform and/or seller control over the funds and can be retained if an agreement is not satisfied, however this method requires manual compliance of the potential purchaser and is inefficient, often requiring the potential purchaser physically go to a banking institution to remit a large wire transaction to the platform. As a result, potential purchaser participation is discouraged, and it does not maximize the amount of money received by the seller of the asset of value.

Furthermore, receiving a manual wire payment as a cash or cash equivalent deposit outside the platform or application is an inefficient method since the management of wires and the ledger must be done manually by the online platform or application personnel, increasing labor costs, time and liability for the online platform and application. As explained in a prior example above, if 36 $5,000 wire deposits are received on a single asset, an individual or group of people must monitor the ledger for receipt of payments and registration status, while also manually conducting and controlling outflows of the wires for the winners, backups and losers. For a scaled online platform with 40 active listings of various sizes, if they all received 36 bids, this would equate to 1,440 manual wires of various sizes and from various parties that a team of people would have to manage manually, risking liability and dramatically increases the risk of mistakes and misappropriation of the purchasers' or sellers' funds.

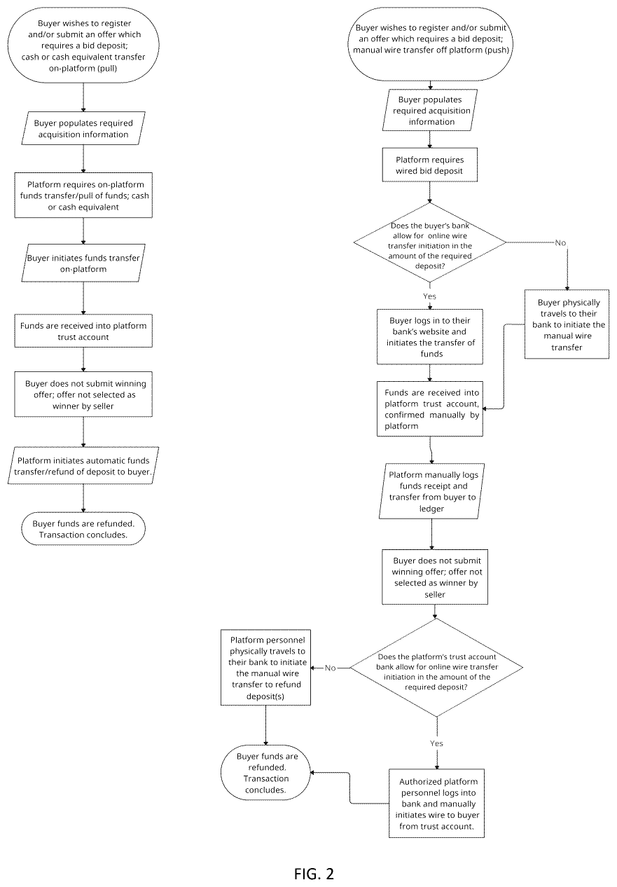

A manual wire payment initiated outside the online platform or application by the potential purchaser to pay a cash or cash equivalent deposit is one example of a PUSH transaction requiring the potential purchaser to log into their online bank account or visit a physical bank location to initiate the wire transaction. In one or more embodiment of the present disclosure described herein, the online platform or application cash or cash equivalent deposit transfer is a PULL transaction requiring the one or more potential purchasers provide bank account or payment information and complete an online checkout to pull a cash or cash equivalent deposit from the potential purchaser's bank account used in the system and methods described herein. FIG. 2 compares the workflow of two different methods that involve a cash or cash equivalent deposit transaction being pulled and a manual wire deposit transaction being pushed. In at least one aspect of at least one embodiment of the present disclosure, the method involves pulling a cash or cash equivalent deposit from the potential purchaser one or more potential purchasers commensurate with their actions within the online platform or application. In at least another embodiment of the present disclosure, the cash or cash equivalent deposit received from the one or potential purchasers is pushed back to the one or more purchasers and the transaction is tracked within an online platform,

As shown in FIG. 2, manual wire payments methods require additional actions from both the potential purchaser and the platform to push the cash or cash equivalent in the transaction and is a less efficient process than pulling a cash or cash equivalent as described in at least one embodiment of the present disclosure. The potential purchaser may even have to physically go into their banking institution to initiate a manual wire transfer, depending on the deposit size and the funds transfer features and capabilities of their banking institution. Furthermore, the platform must manually track deposit amounts for multiple potential purchasers or bidders and then manually push the cash or cash equivalent deposits of the potential purchasers that were not selected back to the potential purchasers or bidders, all of which takes a lot of time and is inefficient.

The issues related to not obtaining any deposit and simply relying on proof of funds puts a significant burden on the platform to verify the validity of the documentation provided by the potential purchaser and lean excessively on the good faith of these potential purchasers to not renegotiate terms or completely fall out prior to executing the contract and providing the EMD. This is the method that is most commonly abused by potential purchasers since documentation can be fabricated. In at least one aspect of at least one embodiment of the present disclosure, when creating an asset to list on the online platform or application, the asset creator, the one or more sellers or the online platform or application requires the cash or cash equivalent bid deposit, to be either set by the asset creator or automatically set and determined by the platform. In at least one other aspect of the embodiment of the present disclosure, when creating the asset, the asset creator may view or review the Bid Deposit Agreement (“BDA”), or an equivalent agreement which is executed by a potential purchaser. The potential purchaser must enter into the agreement in order to submit their cash or cash equivalent deposit to submit an offer or bid on one or more assets of value. The BDA is an agreement between the potential purchaser and the online platform or application, and not an agreement between the seller of the asset and the platform or application, because the online platform or application controls the trust account which holds the deposit, and the system and methods of the invention described herein is provided by the online platform or application.

In at least one aspect of at least one embodiment of the present disclosure, when the asset is listed and the one or more sellers or online platform or application does not initiate a timed event where an offer or bid on one or more assets of value require receiving before a certain deadline, the potential purchasers may submit an offer or bid on the one or more assets at any time. When a potential purchaser submits an offer or bid on one or more assets of value, they review and agree to the BDA, provide their offer or bid terms, and ‘check out’ and submit an offer or bid on the online platform or application by either manually providing bank account and routing number or linking a bank directly by logging into the user interface of their bank through an online platform or application, or by providing their banking account and routing number to the user interface on the online platform. Once the potential purchaser's bank account is linked or their account information is provided, the online purchaser submits the offer and or bid, which is received by the seller or online platform or application.

In at least one aspect of the embodiment of the present disclosure described herein, when an offer or bid is received by the seller(s), the one or more sellers are required to accept an offer or bid submitted by a potential purchaser for one or more assets of value within a specified timeframe and if the offer or bid is not accepted within the timeframe, the cash or cash equivalent deposit, obtained from the potential purchaser is returned to the potential purchaser using the methods and related systems described herein. The time frame is set either by the potential purchaser when they submit their offer or bid, or it is set by the online platform or application using the methods and related systems described within. If the seller accepts the offer, then the bid deposit is held in suspense. When the potential purchaser and one or more sellers close the transaction, at least a portion of the cash or cash equivalent deposit is remitted to the one or more sellers as part of the purchase price, and at least another portion of the cash or cash equivalent deposit is retained by the online platform or application as a fee.

In at least one aspect of at least one embodiment of the present disclosure, if the one or more sellers or the system or online platform sets a timed call for offers (“CFO”) event with a deadline where offers must be received, bidders or potential purchaser can still submit their offers at any time, however the cash or cash equivalent bid deposit will be held in the trust account until the conclusion of the CFO event. The seller(s) are able to extend the CFO deadline as far as they wish, until an offer with a cash or cash equivalent deposit is received. Once that offer is received, the one or more sellers can extend the CFO event one additional time, but only for a set period of time determined by the online platform or application.

When the CFO event concludes, the online platform or application sets a timeframe where the one or more sellers must select a winner (and backup bidders or one or more potential purchasers) or all cash or cash equivalent deposits will be returned to the one or more potential purchasers using the methods and associated systems described within. If the one or more sellers does not select a winner, then all cash and cash equivalent bid deposits are returned to the potential purchasers at the conclusion of this deadline using the online platform or application.

In at least one aspect of at least one embodiment of the present disclosure, when winners and one or more backup offers of the one or more potential purchasers are selected, the cash or cash equivalent deposits paid by the one or more potential purchasers for one or more assets of value are held in suspense and the cash or cash equivalent deposits paid by the losing offers of the one or more potential purchasers for one or more assets of value are returned using the online platform or application. When one or more sellers and one or more potential purchasers enter into an agreement to purchase and close the purchase transaction, the cash or cash equivalent deposits paid by the backup offers or bids are returned through the online platform or application. In another aspect of the embodiment described herein, the online platform or application sets an additional timer when the contract is pending to allow the winning one or more potential purchasers and one or more sellers to complete negotiations and enter into an agreement to purchase the one or more assets of value before the cash or cash equivalent deposit of the one or more backup potential purchasers are returned.

In at least one aspect of at least one embodiment of the present disclosure, one or more sellers allow a second round of a call for offers and allow one or more of the one or more of the original potential purchasers or bidders to revisit their pricing and submit a final offer. In at least one other aspect of one embodiment, the one or more sellers selects one or more offers for one or more assets of value from one or more potential purchasers and changes the online platform or application status of the purchase transaction to show an additional round of offers are being considered. In at least one aspect of at least one embodiment of the present disclosure, when one or more sellers' choses one or more offers for an additional round of allowing offers, the cash or cash equivalent bid deposits are held in the online platform or application trust account for an additional round of allowing offers. Any offers that are not selected, the cash or cash equivalent bid deposits are returned to the one or more potential purchasers using the online platform or application. In one aspect of at least one embodiment, the online platform or application may limit the number of times a one or more sellers can set and allow for a second or more than one round of accepting offers.

In at least one aspect of at least one embodiment of the present disclosure, winners and backups are selected the same way that they are for the first CFO round, and the deposit workflow, contracting and closing process and deposit remittance are handled the same way as they were for the first round CFO, however the online platform or application may require a higher cash or cash equivalent bid deposit amount split for the second round.

In the event of a timed and deadline online auction, potential purchasers will comply with an auction registration process. In this process, they will agree to the BDA and submit their deposit prior to the online auction event, which typically has a window where cash or cash equivalent bids are allowed over a day or multiple days. In this case it will be a single point registration, allowing them to submit multiple cash or cash equivalent bids over the days of the auction event.

The winner will be selected automatically as whoever the highest offer from a potential purchase or bidder is at or over the set reserve pricing. The online platform or application may also select backup bidders automatically, potentially as bidders that did not win but bid at or over the reserve pricing.

Deposit refunds, contracting and closing, as well as deposit remittance workflows are handled in the same process as the other aforementioned instances.

Potential purchasers may link their bank account or provide their banking information either at the point of the transaction/offer submission, the point of the auction registration, or at any time on their potential purchaser profile or user dashboard. This will allow them to speed up the process at the point of transaction if they desire to do so.

In an aspect of at least one embodiment of the present disclosure, the online platform or application checks the balance in the potential purchaser's account and does not process a transaction if the potential purchaser does not have sufficient funds in their account to cover at least part of the cost of the asset of value that the potential purchasers are purchasing.

In an aspect of at least one embodiment of the present disclosure, the one or more potential purchasers provide the online platform or application and/or the one or more sellers of an asset of value with terms in which the one or more potential purchasers agree to follow to purchase the one or more assets of value. The terms can be any material information about the purchase transaction. For example, they can provide an offer price, timing or close, specific terms that they require as part of the purchase transaction or anything else that the buyer or seller requires or desires to be part of the purchase transaction.

Potential purchasers may edit and resubmit their offers any time before the deadline on any CFO event. Edits and resubmissions will not be repeatedly charged for additional deposits. The cash or cash equivalent deposit will only be charged on the first submission on an offer.

One or more sellers or the online platform or application running the sale (collectively “sellers”) will have the ability to reject offers which will automatically refund the potential purchaser's deposits. One or more sellers will have control over the various stages of the process which will also have effects on deposit pushes/pulls.

One or more sellers will also be able to link their bank account information through their profile or dashboard in order to automatically receive their remitted portion of the cash or cash equivalent bid deposit after a successful transaction has been changed to the closed status.

If a potential purchaser does not comply with the terms of their offer as stated in their executed BDA, the cash or cash equivalent deposit is swept for liquidated damages, partially remitted to the one or more sellers and partially remitted to the online platform or application. In this instance, if a backup potential purchaser was previously selected by the one or more sellers, the one or more sellers may designate them as the winner and enter into the contracting and closing process with them.

If a potential purchaser does not comply with the terms of their submitted offer and BDA, the non-performance process is implemented with the non-compliant potential purchaser, and the purchasing process and deposit workflow is continued with a designated back up potential purchaser.

If the one or more sellers opts to remove an asset from any process with the exception of an online auction, any cash or cash equivalent bid deposits submitted from potential purchasers on that asset are automatically refunded to the potential purchasers.

In one aspect of at least one embodiment, XAD is used as a payment workflow to collect a cash bid deposit from a bidder or multiple bidders in a published online transaction as a condition of them submitting an offer or bid.

The systems and methods of the disclosure described herein facilitates the push and/or pull cash transfer of an unlimited number of offers or bids from bidders automatically and refunds the deposits automatically if the one or more sellers does not accept their offer.

In at least one embodiment of the present disclosure, when the potential purchaser is submitting his or her deposit, the potential purchaser executes or agrees to the terms of an agreement which indicates that the one or more prospective purchasers has reviewed the asset details and information, and they are submitting an offer that if accepted, they agree to abide by the terms of the offer as submitted, or the deposit can be swept as liquidated damages.

If an offer is accepted by the one or more sellers, the winner's cash or cash equivalent bid deposit is held in suspense in a trust account controlled by the online platform or application until the transaction is closed.

The one or more sellers can trigger a pull of a portion of the winner's bid deposit funds from the online platform or application trust account via their controls on the online platform or application, which will be applied as part of the winning bidder's total purchase price.

A portion of the cash or cash equivalent bid deposit is assigned to the purchase price, and other portion is retained by the online platform or application as a Platform or Processing Fee.

The invention described herein can be utilized for any online transaction where both parties - the one or more potential purchasers and one or more sellers-must enter into a contract to consummate the transaction. This includes, but is not limited to-home sales, commercial real estate sales, car and boat sales, and fine art sales.

In an aspect of at least one embodiment of the present disclosure, good faith or cash or cash equivalent deposits are required for potential purchasers for them to be able to make an offer or bid on one or more assets of value. Accordingly, the sellers of the one or more assets of value do not expend time and resources to prepare for transaction consummation where multiple quotes are provided, received and reviewed by a potential purchaser and one or more sellers.

In at least one aspect of one embodiment of the present disclosure, when a bidder submits an offer on the online platform or application, they review and agree to the BDA, provide their offer terms, and ‘check out’ of the bidding system by either manually providing their bank account and routing number or linking their bank directly by logging into the user interface of their bank through the online platform or application. Once their bank account is linked or their account information is provided, they submit the offer, which is received by the one or more sellers, the system or platform.

When an offer is received by the one or more sellers, a timeframe is noted and applied to the one or more sellers in which they have to accept or reject the offer.

If the offer is not accepted by the one or more sellers before the conclusion of the time frame or the one or more sellers reject the offer made by one or more sellers, then, in at least one embodiment, the cash or cash equivalent bid deposit is automatically refunded to the potential purchaser by the system, platform or application.

If the one or more sellers accepts the offer, then the cash or cash equivalent bid deposit is held in suspense. When the potential purchaser and one or more sellers close the transaction, a portion of the deposit is remitted to the one or more sellers as part of the purchase price, and the other part is retained by the online platform or application as a fee.

One or more sellers or the online platform or application running the sale (collectively “sellers”) will have the ability to reject offers which will automatically refund the potential purchaser's deposits. One or more sellers will have control over the various stages of the process which will also have effects on deposit pushes or pulls.

One or more sellers will also be able to link their bank account information through their profile or dashboard in order to automatically receive their remitted portion of the cash or cash equivalent bid deposit after a successful transaction has been changed to the closed status.

The online platform or application administrator has access to a payment dashboard, which tracks all transactions, payments/deposits and potential purchaser users which submitted them.

All deposits are tracked to the unique potential purchaser or user and the associated deal and/or transactions, so the exact and correct amount of the deposit can be pulled and refunded in accordance with triggering events by the online platform or application, one or more sellers and/or administrator.

In an aspect of at least one embodiment of the present disclosure, the administrator of the method or system can override all online platform or application transaction commands and manually push or pull deposits to and from one or more potential purchasers or sellers, if so required.

In at least one embodiment of the present disclosure described herein, the system and methods require an online listing or publishing online platform or application to facilitate ‘for sale’ transactions.

In another embodiment of the present invention, the system and methods require the online platform or application be able to receive and track one or multiple offers from multiple unique bidders.

In another embodiment of the present invention, the system and methods require the online platform or application offers a dashboard, or another type of administrative function where one or more sellers can track and accept/reject offers.

In another embodiment of the present disclosure described herein, the system and methods require the online platform or application be able to impose deadlines for actions from either party. Deadlines which are not met by either party automatically trigger specific transaction pushes or pulls based on the stage of the workflow (i.e. all cash or cash equivalent bid deposits are refunded automatically if a one or more sellers does not accept an offer before a certain deadline.)

In another embodiment of the present disclosure described herein, the online platform or application will set deposit amounts due on assets based on transaction size or type.

In another embodiment of the present disclosure described herein, the system and methods require the online platform, or application generates agreements which one or more sellers and potential purchasers execute in the online system in which the potential purchaser or one or more sellers agree to transaction terms and distribution of cash or cash equivalent bid deposit funds. In another embodiment of the present disclosure described herein, the system and methods may include the online platform or application can offer the one or more sellers' functionality to set timers and/or deadlines for receipt of offers in a sealed offer or bid, published offer or bid or traditional incremental bid auction event.

In at least one embodiment of the present disclosure described herein, the system and methods include a payment processing interface for processing cash transactions.

In another embodiment of the invention described herein, the payment processing interface may enable, but is not limited to, Automated Clearing House (ACH), Real Time Payment (RTP), “Fed Now” instant payment transfers, ABA wire transfers and Non-Fungible Token (NFT) purchase with a fiat currency on/off ramp with a financial institution.

In another embodiment of the invention described herein, the payment processing interface is prompted from the listing/publishing online platform or application to conduct push/pull transactions per manual one or more sellers prompts and automated prompts initiated by deadlines imposed by the listing online platform or application.

In another embodiment of the invention described herein, the payment processing interface has an administrative dashboard to track funds transfers. Admin dashboard can organize transactions per user, enabling automated refunds based on prompts from the one or more sellers or online platform or application administrator.

The systems and methods of the disclosure described herein, can be used for a variety of types of online purchase transactions.

In one type of online purchase transaction, the listing is public and without clock or timer constraining marketing.

In another type of online purchase transactions, confidential listings are published to an online platform or application, but may not be readily visible and accessible to the public (i.e. invite only assets and/or password protected listings.)

In another aspect of at least one method or system disclosed herein, a timed call for offers and sealed bid method is provided. At least one of the listings for the one or more assets of value have timers and deadlines where potential purchasers must submit an offer and there can be multiple rounds of offers and counteroffers and/or acceptance. In an aspect of at least one embodiment, each round has a timer and deadline.

In yet another type of online purchase transaction, an online auction, the listings are sold in an online auction event, defined by a single or multiple day event where offers or bids are allowed and received. Typically defined by an event with a starting offer or bid and publicly viewable offers which push the offer or bid price higher.

The systems and methods of the disclosure described herein allows offers and cash or cash equivalent deposits with no Bid Deposit Agreement execution. This is possible by hosting terms and conditions on the online platform or application which indicate implicit agreement with the system and for obtaining a deposit upon acceptance or rejection of an offer. Additionally, the one or more sellers could be prompted to agree with the terms of service of the online platform or application.

In another embodiment of the present disclosure, the system allows for a delayed deposit funds transaction initiation. For a published event, the online platform or application may allow a potential purchaser to submit an offer and their payment information, but delay the transaction draft initiation of the deposit amount until the one or more sellers accepts the offer. If the one or more sellers rejects the offer, the potential purchaser's offer is canceled and the funds are not drafted. The potential purchaser can choose to edit and resubmit their offer.

In yet another embodiment of the present disclosure, the system allows for a timed call for offers event, wherein the potential purchaser may be allowed to submit an offer, and payment information, however the funds are not drafted or initiated until the conclusion of the bidding event.

In at least one embodiment of the present disclosure, the online platform or application allows for potential purchasers to submit offers and one or more sellers to counter pricing or terms of these offers without immediate return of funds resulting from an offer rejection.

In another embodiment of the present disclosure, both potential purchasers and one or more sellers can edit and resubmit offers without return of funds or multiple charges of deposit funds.

In yet another embodiment of the present disclosure, the offer is accepted, the funds process through the fund's workflows. If the offer is rejected by the one or more sellers or canceled by the potential purchaser, the funds are refunded to the potential purchaser.

In one embodiment, the method disclosed herein uses, but is not limited to, the following technology for the online platform or application parameters. Python, Pyramid, Terraform, Docker, VueJS, Vuetify, Apexchart, Cognito, DynamoDB, S3, Lambda, ElasticSearch, AppSync, StepFunction, EC2, SES, Fargate, Route53, Cloudwatch, ACM, ECR, SQS, SNS, IAM, EventBridge, Stripe, Vopay, Plaid, Google Tag Manager, Hotjar, Hubspot, Mailjet, Twilio, Sentry, Zentinel, Google Maps and Places.

In at least one embodiment of the present disclosure, an online platform or application uses at least one or more types of technologies including an online bidding platform, an online marketplace, a virtual data room, and an online marketing website.

In another embodiment of the present disclosure, the online platform or application, the technology consists of an API and database that drives business processes and serves as a point of access to the bidding functionality for marketplaces. The technology allows other marketplaces to use the same database and provides seamless integration.

In another embodiment of the present disclosure, the marketplace interface allows users access to the main functionality and provides a convenient and easy-to-use interface for users to view offers or bids, create offers or bids, and access other features.

In another embodiment of the present disclosure, the marketing website serves as the main source of information about the asset and its capabilities and includes registration forms and instructions for using the online platform or application.

In an aspect of one embodiment of the present disclosure, an end-to-end encrypted data sharing and privacy online platform that allows for simple sharing and control of sensitive information with full audit logging of access and changes to support compliance of Federal, State, International, and Industry regulations is used. One example of an end-to-end encrypted data sharing and privacy platform that could be used is Zentinel.

In one aspect of at least one embodiment of the present disclosure, the system is hosted on Amazon Web Services (“AWS”) and built on several Amazon services, including Cognito for authentication, DynamoDB for database management, S3 for storage, Lambda for serverless computing, ElasticSearch for search functionality, and AppSync for real-time data synchronization. The methods and systems of the present disclosure can use any language for development. In one embodiment, Python, Chalice, Terraform, and or/Robot Framework can be used for development and VueJS can be used for the user interface. Additionally, Google Maps and Places integration was required to support the online platform or application's focus on real estate.

In yet another embodiment of the present disclosure, the payment processing system is used for both subscription billing & invoicing, as well as processing deposit payments. Stripe was selected as the subscription payment solution for credit card transactions/invoicing due to its ease of integration and security features. Vopay and Plaid was implemented for the ACH cash or cash equivalent deposit transactions which occur in the asset selling/bidding workflows.

In at least one embodiment of the present disclosure, a developer would have to chart out the timing of a transaction in order to establish guardrails, deadlines and controls for the flow of funds. For the invention to function properly, it must be able to operate without direct intervention from the online platform or administrator for the transaction to be listed, published, for offers and deposits to be received and refunded as required within the timeframe of the transaction.

In at least one embodiment of the present disclosure, the invention requires a website application with an online time and calendar system for sellers to establish timing and deadlines or the marketing and sale of an asset or assets of value, but also for the platform to establish deadline requirements for both the buyer and the seller to comply. Certain dates, times and deadlines will be dictated by the seller in the course of marketing, and when deposits are received, certain times and deadlines must be established by the platform using the time and calendar function. This will prevent sellers from indefinitely delaying offer acceptance and preventing the refund and remittance of a deposit back to a buyer. Times and deadlines are also applied to the buyer to compel compliance and prevent re-trading or renegotiating through lack of contact and follow-up.

In one aspect of at least one embodiment of the present disclosure, the timer and calendar system on the online platform will interact with a payment processing system via Application Programming Interface (API) or other internet communication protocol online to automatically initiate push and pull transactions between the buyer, seller and online platform.

In another embodiment of the present disclosure, a system is provided. The system comprises (1) a memory comprising computer-executable instructions; (2) one or more processors in communication with the memory and configured to access the memory and execute the computer-executable instructions to at least (a) generate information or instructions regarding one or more sellers or one or more assets of value that one or more sellers' desire to sell, (b) generate information or instructions regarding one or more potential purchasers or the one or more assets of value that the one or more potential purchasers' desire to purchase, (c) generate information or instruction regarding the one or more potential purchasers agree to pay or paying a cash or cash equivalent deposit to have the ability and/or right to purchase one or more assets of value, (d) generating information or instructions regarding the cash or cash equivalent deposit that the one or more potential purchasers paid, (e) generating information or instructions regarding the transfer of at least a portion of the cash or cash equivalent deposit paid by the one or more potential purchaser, (f) generating information or instructions regarding or receiving instructions from the one or more potential purchasers to purchase one or more assets of value, (g) generating information or instructions regarding the cash or cash equivalent deposit received from the one or more purchasers that is to be returned to the one or more purchasers that were not selected to purchase the one or more assets of value; and (h) generating information or instructions regarding returning the cash or cash equivalent deposit to the one or more purchasers from which it was received when and if the seller of the asset of value does not satisfy the terms of the agreement with the seller of the asset of value.

In another embodiment of the present disclosure, generating information or instructions regarding returning the cash or cash equivalent deposit received from the one or more purchasers to the one or more purchasers that were not selected to purchase the one or more assets of value includes providing information or instructions regarding returning at least a portion of the cash or cash equivalent deposit to the one or more purchasers.

In another embodiment of the present disclosure, generating information or instructions regarding the cash or cash equivalent deposit paid by the one or more potential purchasers is held or controlled by the system.

In another embodiment of the present disclosure, generating information or instructions regarding the cash or cash equivalent deposit paid by the one or more potential purchasers is determined or controlled by the system.

In another embodiment of the present disclosure, the information or instructions regarding the cash or cash equivalent deposit to purchase the one or more assets of value is received by the system before the one or more of the one or more potential purchasers of a particular asset of value are chosen or identified.

In another embodiment of the present disclosure, the information or instructions regarding the cash or cash equivalent deposit to purchase the one or more assets of value is requested by the system from the one or more potential purchasers shortly after the one or more potential purchasers makes an offer to purchase the one or more assets of value.

In another embodiment or aspect of the present disclosure, the system generates information or instructions regarding receiving bank account or payment information from the one or more potential purchaser of the one or more assets of value and/or receiving a wire, ACH or bank to bank payment as the cash or cash equivalent deposit from the one or more purchasers.

In another embodiment of the present disclosure, (1) a memory comprising computer-executable instructions, (2) one or more processors in communication with the memory and configured to access the memory and execute the computer-executable instructions to at least: (a) generating information or instructions regarding entering into an agreement with one or more sellers of one or more assets of value to facilitate the sale of the one or more assets of value, (b) generating information or instructions regarding one or more potential purchasers of the one or more assets of value paying a cash or cash equivalent deposit, (c) generating information or instructions regarding the one or more potential purchasers the ability and/or right to purchase one or more assets of value; (d) generating information or instructions regarding the one or more potential purchasers forfeiting at least a portion of the cash or cash equivalent deposit that the one or more potential purchasers paid, (e) generating information or instructions regarding the cash or cash equivalent deposit received from the one or more purchasers (f) generating information or instructions regarding returning the cash or cash equivalent deposit received from the one or more purchasers that were not selected to purchase the one or more assets of value to the one or more purchasers that were not selected; (g) generating information or instruction regarding returning the cash or cash equivalent deposit to the one or more purchasers from which it was received if and when the seller of the asset of value does not satisfy the terms of the agreement with the seller of the asset of value and (h) generating information or instructions to share at least a portion of the cash or cash equivalent deposit obtained from the one or more potential purchasers with the system, platform or application.

In another embodiment of the present disclosure, a system is provided, comprising a memory comprising computer-executable instructions and one or more processors in communication with the memory and configured to access the memory and execute the computer-executable instructions to at least: (a) generating information or instructions regarding entering into an agreement with one or more sellers of one or more assets of value to facilitate the sale of the one or more assets of value, (b) generating information or instructions regarding entering into an agreement with one or more potential purchasers of the one or more assets of value, (c) generating information or instructions regarding the one of more potential purchasers agree to pay a cash or cash equivalent deposit to have the ability and/or right to purchase one or more assets of value, (d) generating information or instructions regarding the one or more potential purchasers agree to forfeit at least a portion of the cash or cash equivalent deposit that the one or more potential purchasers paid, (e) generating information or instructions regarding receiving from the one or more potential purchasers a cash or cash equivalent deposit to purchase one or more assets of value, (f) generating information or instructions regarding returning the cash or cash equivalent deposit received from the one or more purchasers to the one or more purchasers that were not selected to purchase the one or more assets of value; (g) generating information or instructions regarding returning the cash or cash equivalent deposit to the one or more purchasers from which it was received when the seller of the asset of value does not satisfy the terms of the agreement with the seller of the asset of value, and (h) generating information or instructions regarding the one or more sellers of one or more assets of value paying the system, online platform or application a fee if the seller's one or more assets of value are sold to the one or purchasers on the system, online platform or application.

In another embodiment of the present disclosure, the system further comprises generating information or instructions regarding the one or more sellers of one or more assets of value being able to accept or reject an offer from one or more prospective purchasers of an asset of value using the system, online platform or application.

In another embodiment of the present disclosure, the system further comprises generating information or instruction regarding the one or more sellers of one or more assets rejecting an offer from the one or more prospective purchasers.

In another embodiment of the present disclosure, the system automatically returns the cash or cash equivalent deposit to the prospective purchaser whose offer was rejected by the one or more sellers of an asset of value.

What is claimed is:

1. A system, comprising:
a memory comprising computer-executable instructions; and
one or more processors in communication with the memory and configured to access the memory and execute the computer-executable instructions to at least:
generate information or instructions regarding one or more sellers or one or more assets of value that one or more sellers' desire to sell;
generate information or instructions regarding one or more potential purchasers or the one or more assets of value that the one or more potential purchasers' desire to purchase;
generate information or instruction regarding the one or more potential purchasers agree to pay or paying a cash or cash equivalent deposit to have the ability and/or right to purchase one or more assets of value;
generating information or instructions regarding the cash or cash equivalent deposit that the one or more potential purchasers paid;
generating information or instructions regarding the transfer of at least a portion of the cash or cash equivalent deposit paid by the one or more potential purchaser;
generating information or instructions regarding or receiving instructions from the one or more potential purchasers to purchase one or more assets of value;
generating information or instructions regarding the cash or cash equivalent deposit received from the one or more purchasers that is to be returned to the one or more purchasers that were not selected to purchase the one or more assets of value; and
generating information or instructions regarding returning the cash or cash equivalent deposit to the one or more purchasers from which it was received when and if the seller of the asset of value does not satisfy the terms of the agreement with the seller of the asset of value.

2. The system of claim 1, wherein generating information or instructions regarding returning the cash or cash equivalent deposit received from the one or more purchasers to the one or more purchasers that were not selected to purchase the one or more assets of value includes providing information or instructions regarding returning at least a portion of the cash or cash equivalent deposit to the one or more purchasers.

3. The system of claim 1, wherein generating information or instructions regarding the cash or cash equivalent deposit paid by the one or more potential purchasers is held or controlled by the system.

4. The system of claim 1, wherein generating information or instructions regarding the cash or cash equivalent deposit paid by the one or more potential purchasers is determined or controlled by the system.

5. The system of claim 1, wherein the information or instructions regarding the cash or cash equivalent deposit to purchase the one or more assets of value is received by the system before the one or more of the one or more potential purchasers of a particular asset of value are chosen or identified.

6. The system of claim 1, wherein the information or instructions regarding the cash or cash equivalent deposit to purchase the one or more assets of value is requested by the system from the one or more potential purchasers shortly after the one or more potential purchasers makes an offer to purchase the one or more assets of value.

7. The system of claim 1, the system additionally comprising:
generate information or instructions regarding receiving bank account or payment information from the one or more potential purchaser of the one or more assets of value and/or receiving a wire, ACH or bank to bank payment as the cash or cash equivalent deposit from the one or more purchasers.

8. A system, comprising:
a memory comprising computer-executable instructions; and
one or more processors in communication with the memory and configured to access the memory and execute the computer-executable instructions to at least:
generating information or instructions regarding entering into an agreement with one or more sellers of one or more assets of value to facilitate the sale of the one or more assets of value;
generating information or instructions regarding one or more potential purchasers of the one or more assets of value paying a cash or cash equivalent deposit;
generating information or instructions regarding the one or more potential purchasers the ability and/or right to purchase one or more assets of value;
generating information or instructions regarding the one or more potential purchasers forfeiting at least a portion of the cash or cash equivalent deposit that the one or more potential purchasers paid;
generating information or instructions regarding the cash or cash equivalent deposit received from the one or more purchasers;
generating information or instructions regarding returning the cash or cash equivalent deposit received from the one or more purchasers that were not selected to purchase the one or more assets of value to the one or more purchasers that were not selected;
generating information or instruction regarding returning the cash or cash equivalent deposit to the one or more purchasers from which it was received if and when the seller of the asset of value does not satisfy the terms of the agreement with the seller of the asset of value; and
generating information or instructions to share at least a portion of the cash or cash equivalent deposit obtained from the one or more potential purchasers with the system, platform or application.

9. The system of claim 8, wherein generating information or instructions regarding returning the cash or cash equivalent deposit received from the one or more purchasers to the one or more purchasers that were not selected to purchase the one or more assets of value includes providing information or instructions to return at least a portion of the cash or cash equivalent deposit to the one or more purchasers.

10. The system of claim 8, wherein generating information or instructions regarding the cash or cash equivalent deposit paid by the one or more potential purchasers is held or controlled by the system, platform or application.

11. The system of claim 8, wherein generating information or instructions regarding the cash or cash equivalent deposit paid by the one or more potential purchasers is held or controlled by the system.

12. The system of claim 8, wherein generating information or instructions regarding the cash or cash equivalent deposit to purchase the one or more assets of value is generated before the one or more of the one or more potential purchasers of a particular asset of value are chosen or identified.

13. The system of claim 8, wherein generating information or instructions regarding the cash or cash equivalent deposit to purchase the one or more assets of value is generated or requested from the one or more potential purchasers shortly after the one or more potential purchasers makes an offer to purchase the one or more assets of value.

14. A system, comprising:
a memory comprising computer-executable instructions; and
one or more processors in communication with the memory and configured to access the memory and execute the computer-executable instructions to at least:
generating information or instructions regarding entering into an agreement with one or more sellers of one or more assets of value to facilitate the sale of the one or more assets of value;
generating information or instructions regarding entering into an agreement with one or more potential purchasers of the one or more assets of value;
generating information or instructions regarding the one of more potential purchasers agree to pay a cash or cash equivalent deposit to have the ability and/or right to purchase one or more assets of value;
generating information or instructions regarding the one or more potential purchasers agree to forfeit at least a portion of the cash or cash equivalent deposit that the one or more potential purchasers paid;
generating information or instructions regarding receiving from the one or more potential purchasers a cash or cash equivalent deposit to purchase one or more assets of value;
generating information or instructions regarding returning the cash or cash equivalent deposit received from the one or more purchasers to the one or more purchasers that were not selected to purchase the one or more assets of value;
generating information or instructions regarding returning the cash or cash equivalent deposit to the one or more purchasers from which it was received when the seller of the asset of value does not satisfy the terms of the agreement with the seller of the asset of value; and
generating information or instructions regarding the one or more sellers of one or more assets of value paying the system, online platform or application a fee if the seller's one or more assets of value are sold to the one or purchasers on the system, online platform or application.

15. The system of claim 14, wherein generating information or instructions regarding returning the cash or cash equivalent deposit received from the one or more purchasers to the one or more purchasers that were not selected to purchase the one or more assets of value includes returning at least a portion of the cash or cash equivalent deposit to the one or more purchasers.

16. The system of claim 14, wherein generating information or instructions regarding the cash or cash equivalent deposit paid by the one or more potential purchasers is held or controlled by the system, platform or application.

17. The system of claim 14, wherein generating information or instructions regarding the cash or cash equivalent deposit paid by the one or more potential purchasers is held or controlled by the system.

18. The system of claim 14, wherein generating information or instructions regarding the cash or cash equivalent deposit to purchase the one or more assets of value is received by the system before the one or more of the one or more potential purchasers of a particular asset of value are chosen or identified by the seller of the one or more assets of value.

19. The system of claim 14, wherein generating information or instruction regarding the cash or cash equivalent deposit paid to purchase the one or more assets of value is generated shortly after the one or more potential purchasers makes an offer to purchase the one or more assets of value.

20. The system of claim 14, further comprising generating information or instructions regarding the one or more sellers of one or more assets of value being able to accept or reject an offer from one or more prospective purchasers of an asset of value using the system, online platform or application and when the one or more sellers of one or more assets rejects an offer from the one or more prospective purchasers, the cash or cash equivalent deposit received from the prospective purchaser who's offer was rejected by seller of the one or more assets of value is automatically returned by the system to the prospective purchaser who's offer was rejected by the one or more sellers of an asset of value.
